(19) United States
(12) Patent Application Publication
(10) Pub. No.: US 2025/0285196 A1
(43) Pub. Date: Sep. 11, 2025

(54) METHOD AND SYSTEM FOR CALCULATING NET PRESENT VALUE OF REAL PROPERTY

(71) Applicant: Bradley Donald Ross, Phoenix, AZ (US)

(72) Inventor: Bradley Donald Ross, Phoenix, AZ (US)

(21) Appl. No.: 19/075,273

(22) Filed: Mar. 10, 2025

Related U.S. Application Data
(60) Provisional application No. 63/562,874, filed on Mar. 8, 2024.

(51) Int. Cl. G06Q 50/02; G06Q 30/0201

(52) U.S. Cl. CPC G06Q 50/02; G06Q 30/0206

(57) ABSTRACT

A system and method for calculating the net present value (NPV) of real property, particularly for mining or mineral extraction sites, is disclosed. This system addresses the challenge of valuing subsurface rights, such as mineral and mining rights, often overlooked by traditional valuation tools. It utilizes publicly available data to model market trends and calculate the NPV of properties. The method involves receiving a property identifier, retrieving relevant data, calculating the property value using additional data, and outputting the result to a user interface. This approach aids in economic decision-making in the mining industry by providing a comprehensive valuation that includes both surface and subsurface rights.

### CROSS-REFERENCE TO RELATED APPLICATION

This application claims the benefit of priority of U.S. provisional application No. 63/562,874, filed Mar. 8, 2024, the contents of which are herein incorporated by reference.

### BACKGROUND OF THE INVENTION

The present invention relates to a system and method for calculating the value of real property and, more particularly, to a system and method for calculating the net present value of royalty payments projected to be received from mining activities at a given mining site.

Current real property valuation tools only value real property based on surface rights, i.e., the value of the land and any improved structure on the land, if such structures exist. There is no consideration in the current tools for valuation of subsurface rights, i.e., mining or mineral rights. Conventional tools are inefficient because they cannot properly determine the value of real property when the primary monetary consideration is the subsurface rights, or subsurface production capability.

As can be seen, there is a need for a tool that can accurately value mineral and mining rights such that these values can be taken into consideration when making economic decisions.

### SUMMARY OF THE INVENTION

Broadly, an embodiment of the present invention provides a system and process for utilizing publicly available information to establish market trends to value real property, wherein the real property can be used for mining or mineral extraction purposes and further provides a net present value calculation of the real property value.

An embodiment of the present invention gathers publicly available information about mining sites, or mineral extract facilities, and uses that data to model market derived data for each site. The market derived data is, in turn, correlated with established values in order to ensure that the data is valid.

These and other features, aspects and advantages of the present invention will become better understood with reference to the following drawings, description and claims.

### BRIEF DESCRIPTION OF THE DRAWINGS

FIG. 1 is a diagram of the Net Present Value Calculation Environment, according to aspects of the present invention;

FIG. 2 is a table showing data calculations for the modeling process, according to aspects of the present invention;

FIG. 3 is an exemplary embodiment of a graphical user interface according to aspects of the present invention; and

FIG. 4 is a data flow diagram of the present value modeling method, according to aspects of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Valuation of subsurface rights, like mineral and mining rights, is a non-trivial task, and current automated tools provide no mechanism for consideration of subsurface rights in the valuation of real property. Several market dependent factors influence the valuation of mineral rights. These factors and their interdependence are typically discerned using decades of experience.

Broadly, an embodiment of the present invention provides a system and process for utilizing publicly available information to establish market trends to value real property, wherein the real property can be used for mining or mineral extraction purposes, and further provides a net present value calculation of the real property value.

An embodiment of the present invention gathers publicly available information about mining sites, or mineral extract facilities, and uses that data to model market derived data for each site. The market derived data is, in turn, correlated with established values in order to ensure that the data is valid.

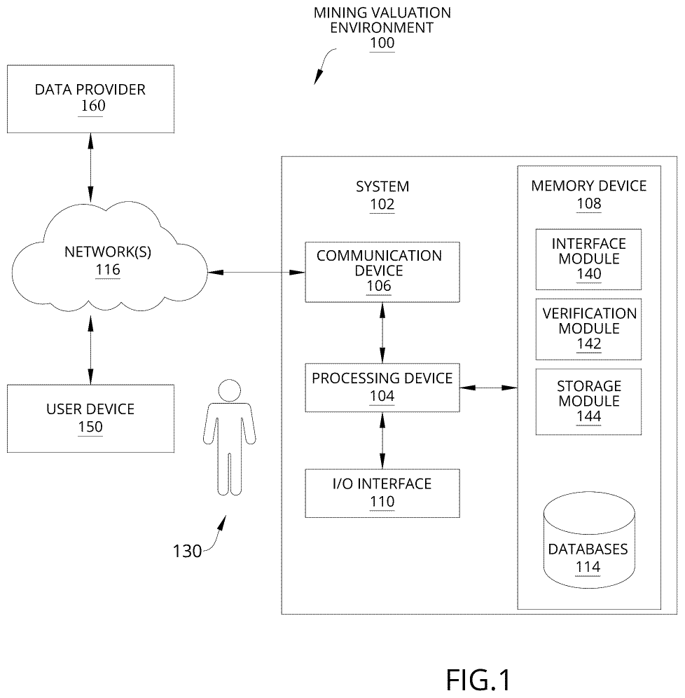

Referring now to FIG. 1, FIG. 1 illustrates a mining valuation environment 100, according to aspects of the present disclosure. The mining valuation environment 100 includes a system 102 that models and calculates the net present value of mining, or mineral extraction, properties.

As illustrated in FIG. 1, the system 102 includes a processing device 104 coupled to a communication device 106. The processing device 104 is also coupled to a memory device 108, a storage module 144, and an input/output (“I/O”) interface 110. In certain embodiments, the communication device 106 enables the system 102 to communicate with other devices and systems via one or more networks 116. The system 102 can communicate with a user device 150 and/or a data provider 160 via the network 116. The user device 150 and/or the data provider 160 can include one or more electronic devices such as a laptop computer, a desktop computer, a tablet computer, a smartphone, a thin client, and the like.

According to the aspects of the present disclosure, the system 102 enables a user 130, to interact with a net present value verification module 142 and an interface module 140, via I/O interface 110, to determine a series of net present values for a given mining, or mineral extraction, property.

To perform the process described herein, the system 102 can store and execute the interface module 140, the net present value verification module 142, and a storage module 144 to perform the processes and methods described herein. The interface module 140, the net present value module 142, and the storage module 144 can be stored in the memory device 108. The interface module 140, the net present value module 142, and the storage module 144 can include the necessary logic, instructions, and/or programming to perform the processes and methods described herein. The interface module 140, the net present value module 142, and the storage module 144 can be written in any programming language. In some embodiments, the application can be a specifically designed application that operates with the system 102 to perform the processes and methods described herein. In some embodiments, the application can be a third-party application, such as a web browser, that communicates with the system 102 to perform the processes and methods described herein.

The memory device 108 can also include a database 114 that stores information and data associated with the process and methods described herein. The database 114 can store data retrieved from data provider 160, along with additional data used by the net present value module 142 for determining model and forecasting parameters.

The interface module 140 operates to generate and provide graphical user interfaces (GUIs) to the net present value module 142, for example, menus, widgets, text, images, fields, etc. The GUIs generated by the interface module 140 can be interactive. For example, the GUI can allow the users of the user devices 130 to access and interact with datum that are received and stored by the system 102 and/or the net present value module 142.

The net present value module 142 operates to model and calculate the net present value for mining, or mineral extraction, properties based on at least one retrieved data and at least one piece of additional data.

The processing device 104, the communication device 106, the memory device 108, the storage device 110, and the I/O interface 110 can be interconnected via a system bus. The system bus can be and/or include a control bus, a data bus, and address bus, and so forth. The processing device 104 can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and so forth. As used herein, “processor,” “processing component,” “processing device,” and/or “processing unit” can be used generically to refer to any or all of the aforementioned specific devices, elements, and/or features of the processing device. While FIG. 1 illustrates a single processing device 104, the system 102 can include multiple processing devices 104, whether the same type or different types.

The memory device 108 can be and/or include computerized storage medium capable of storing electronic data temporarily, semi-permanently, or permanently. The memory device 108 can be or include a computer processing unit register, a cache memory, a magnetic disk, an optical disk, a solid-state drive, and so forth. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device. While FIG. 1 illustrates a single memory device 108, the system 102 can include multiple memory devices 108, whether the same type or different types.

The communication device 106 enables the system 102 to communicate with other devices and systems. The communication device 106 can include, for example, a networking chip, one or more antennas, and/or one or more communication ports. The communication device 106 can generate radio frequency (RF) signals and transmit the RF signals via one or more of the antennas. The communication device can receive and/or translate the RF signals. The communication device can transceive the RF signals. The RF signals can be broadcast and/or received by the antennas.

The communication device 106 can generate electronic signals and transmit the RF signals via one or more of the communication ports. The communication device 106 can receive the RF signals from one or more of the communication ports. The electronic signals can be transmitted to and/or from a communication hardline by the communication ports. The communication device 106 can generate optical signals and transmit the optical signals to one or more of the communication ports. The communication device 106 can receive the optical signals and/or can generate one or more digital signals based on the optical signals. The optical signals can be transmitted to and/or received from a communication hardline by the communication port, and/or the optical signals can be transmitted and/or received across open space by the networking device.

The communication device 106 can include hardware and/or software for generating and communicating signals over a direct and/or indirect network communication link. For example, the communication device 106 can include a universal serial bus (“USB”) port and a USB wire, and/or an RF antenna with Bluetooth™ programming installed on a processor, such as the processing component, coupled to the antenna. In another example, the communication component can include an RF antenna and programming installed on a processor, such as the processing device, for communicating over a wireless fidelity (“WiFi”) WiFi and/or cellular network. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network.

An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

The system 102 can communicate with one or more network resources via the network 116. The one or more network resources can include external databases, social media platforms, search engines, file servers, web servers, or any type of computerized resource that can communicate with the system 102 via the network 116.

In embodiments, the components and functionality of the system 102 can be hosted and/or instantiated on a “cloud” or “cloud service.” As used herein, a “cloud” or “cloud service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

In embodiments, the components and functionality of the system 102 can be and/or include a “server” device. The term server can refer to functionality of a device and/or an application operating on a device. For example, an application server can be programming instantiated in an operating system installed on a memory device and run by a processing device. The application server can include instructions for receiving, retrieving, storing, outputting, and/or processing data. A processing server can be programming instantiated in an operating system that receives data, applies rules to data, makes inferences about the data, and so forth. Servers referred to separately herein, such as an application server, a processing server, a collaboration server, a scheduling server, and so forth can be instantiated in the same operating system and/or on the same server device. Separate servers can be instantiated in the same application or in different applications.

The server device can include a physical server, a virtual server, and/or cloud server. For example, the server device can include one or more bare-metal servers such as single-tenant servers or multiple-tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers.

Various aspects of the systems described herein can be referred to as “content” and/or “data.” Content and/or data can be used to refer generically to modes of storing and/or conveying information. Accordingly, data can refer to textual entries in a table of a database. Content and/or data can refer to alphanumeric characters stored in a database. Content and/or data can refer to machine-readable code. Content and/or data can refer to images. Content and/or data can refer to audio and/or video. Content and/or data can refer to, more broadly, a sequence of one or more symbols. The symbols can be binary. Content and/or data can refer to a machine state that is computer-readable. Content and/or data can refer to human-readable text.

Various of the devices in the mining valuation environment 100, including the system 102, the user device 150, and the data provider 160, can include a user interface for outputting information in a format perceptible by a user and receiving input from the user. For example, the system 102 can communicate with the user interface via the I/O interface 110. The user interface can display graphical user interfaces (“GUIs”) generated by the system 102. The user interface can include a display screen such as a light-emitting diode (“LED”) display, an organic LED (“OLED”) display, an active-matrix OLED (“AMOLED”) display, a liquid crystal display (“LCD”), a thin-film transistor (“TFT”) LCD, a plasma display, a quantum dot (“QLED”) display, and so forth. The user interface can include an acoustic element such as a speaker, a microphone, and so forth. The user interface can include a button, a switch, a keyboard, a touch-sensitive surface, a touchscreen, a camera, a fingerprint scanner, and so forth. The touchscreen can include a resistive touchscreen, a capacitive touchscreen, and so forth.

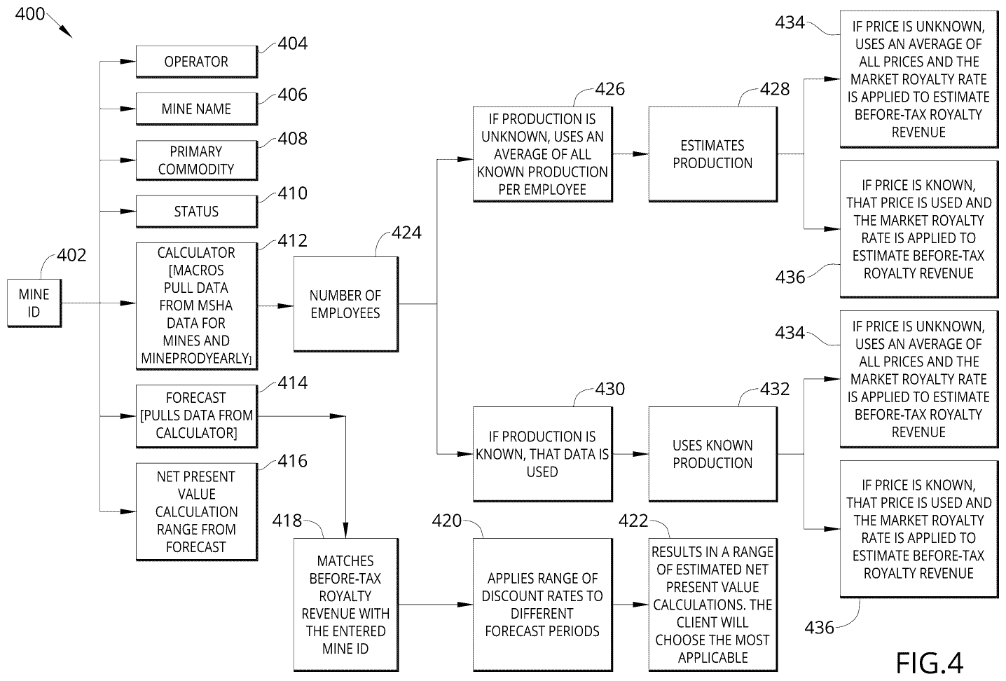

A method for calculating the net present value of real property used in mining, or mineral extraction operations is now described. The method relies on robust public information and unique relationships between data to model the net present value of mining, or mineral extraction, properties. FIG. 4 depicts data flow for the present value modeling method, according to aspects of the present disclosure.

The method begins where a real property identifier can be entered into system 102 via interface module 140. Interface module 140 receives the real property identifier via either I/O interface 110 or user device 130. While it is contemplated that the real property identifier can be a unique identifier, in one embodiment the real property identifier is a mine identifier.

The real property identifier can be used, by system 102, to query data provider 160 through communication device 106, in order to retrieve at least one piece of data about the real property. In an exemplary embodiment, the real property identifier is a mine ID that queries the publicly available Mine Safety and Health Administration data, and the at least one piece of data that can be retrieved can be one or more of the following: operator name, mine name, primary commodity, secondary commodity, operating status, or number of employees.

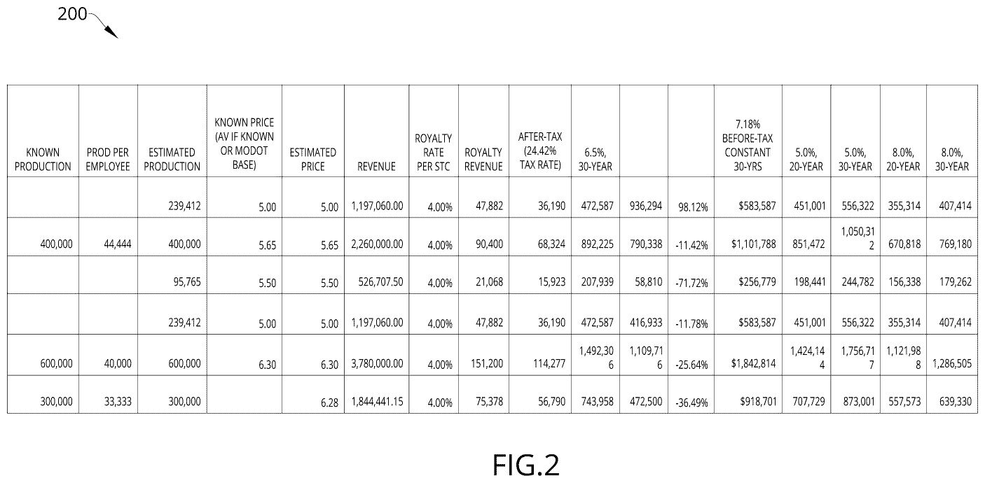

Once data is retrieved by system 102, the data can be fed to the net present value module 142, where the net present value of the real property is calculated using the retrieved data and at least one additional piece of data. In one embodiment, the calculation can proceed in the net present value module 142 by determining a number of known values, or in the absence of known values, substituting an estimated value as the at least one additional piece of data. In an exemplary embodiment, the at least one additional piece of data can be one or more of the following: known production, production per employee, estimated production, known price of a commodity, or estimated price of a commodity. Furthermore, the at least one retrieved data and the at least one additional piece of data can be used to model or calculate a before tax royalty revenue. Finally, a forecast is applied to the before tax royalty revenue by applying a range of discount rates along with different forecast periods, which can result in a range of calculated net present values. FIG. 2 shows data calculations for the modeling process.

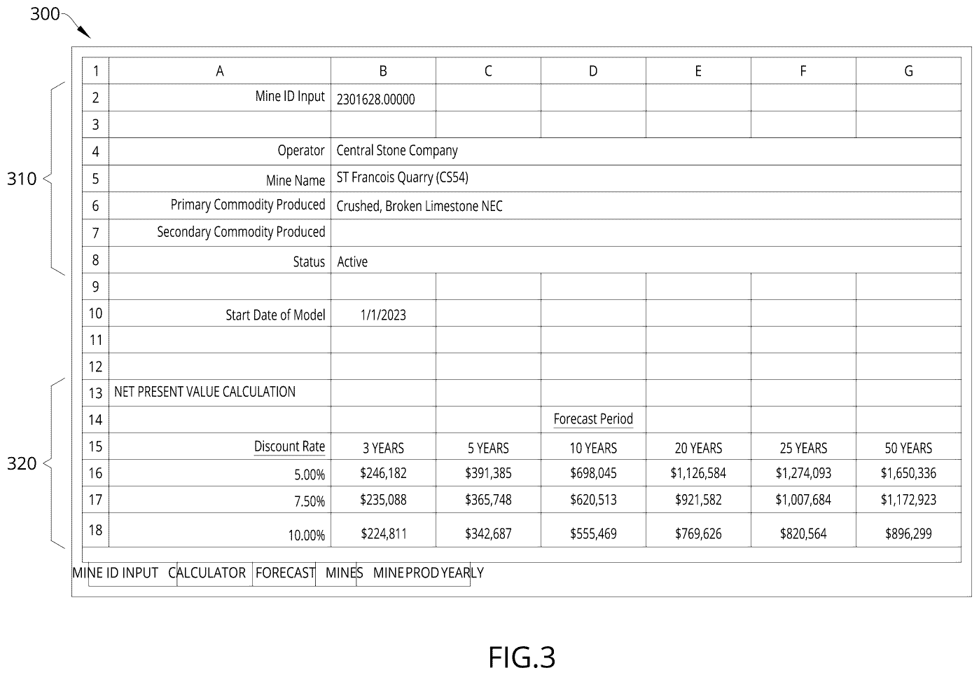

The net present value ranges can be output to a user interface for selection by a user. For example, FIG. 3 illustrates an example of a GUI 300 that can be presented to the user. As illustrated, the GUI 300 can include an informational section 310 that lists the details of a mine being evaluated, e.g., mine ID, Operator, Mine Name, Commodity produced, and Status. The GUI 300 can also include a table 320 that displays net present value for different discount rates and time periods.

It should be understood, of course, that the foregoing relates to exemplary embodiments of the invention and that modifications can be made without departing from the spirit and scope of the invention as set forth in the following claims.

What is claimed is:

1. A method for calculating the net present value for mineral properties, the method comprising:
receiving an identifier, wherein the identifier uniquely identifies a real property;
retrieving at least one piece of data, using the identifier, wherein the at least one piece of data includes at least one of: operator name, mine name, primary commodity, secondary commodity, operating status, or number of employees;
calculating a value of the real property using the at least one piece of data, and at least one additional piece of data; and
outputting the value of the real property to a user interface.

2. A system for calculating the net present value for mineral properties, the system comprising:
a processing device in communication with a communication device and an input/output interface, and a memory device;
the memory device comprising an interface module, a net present value verification module, and a storage module;
wherein a real property identifier can be entered into system via interface module, and interface module receives the real property identifier via the I/O interface.

3. The system of claim 2, wherein the system uses the real property identifier to query the data provider through the communication device in order to retrieve at least one piece of data about the real property.

4. The system of claim 3, wherein the real property identifier is a mine ID that queries publicly available Mine Safety and Health Administration data, and the at least one piece of data that can be retrieved can be one or more of the following: operator name, mine name, primary commodity, secondary commodity, operating status, or number of employees.

5. The system of claim 4, wherein the retrieved data is fed to the net present value module, and wherein the net present value of the real property is calculated using the retrieved data and at least one additional piece of data.

6. The system of claim 4, wherein the calculation proceeds in the net present value module by determining a number of known values.

7. The system of claim 4, wherein the calculation proceeds in the net present value module by substituting an estimated value as the at least one additional piece of data.

8. The system of claim 4, wherein the at least one additional piece of data can be one or more of the following: known production, production per employee, estimated production, known price of a commodity, or estimated price of a commodity.

9. The system of claim 4, wherein the at least one retrieved data and the at least one additional piece of data can be used to model or calculate a before tax royalty revenue.

10. The system of claim 9, wherein a forecast is applied to the before tax royalty revenue by applying a range of discount rates along with different forecast periods, resulting in a range of calculated net present values.
